(19) United States
(12) Patent Application Publication
(10) Pub. No.: US 2006/0230069 A1
(43) Pub. Date: Oct. 12, 2006

(54) Media transmission method and a related media provider that allows fast downloading of animation-related information via a network system

(75) Inventor: Bong-Foo Chu, Macau (MO)

Correspondence Address: THE LAW OFFICES OF MIKIO ISHIMARU, 333 W. EL CAMINO REAL, SUITE 330, SUNNYVALE, CA, 94087, US

(73) Assignee: CULTURE.COM TECHNOLOGY (MACAU) LTD., Macau (MO)

(21) Appl. No.: 11/301,864

(22) Filed: Dec. 12, 2005

(30) Foreign Application Priority Data
Apr. 12, 2005 (TW) 94111457

(51) Int. Cl. G06F 17/00

(52) U.S. Cl. 707/104.1

(57) ABSTRACT

A media transmission method and a related media provider are provided for transmitting media to an electronic device including a multimedia chip and a terminal database via a network system. The media provider has a summary database for storing a plurality of objects and their basic information, a media generating module for allowing a content editor who logins a media transmission system where the media provider is installed to select the objects stored in the summary database and design actions of the selected objects, a media database for storing the content of the media generated by the media generating module, and an animation-related information generating module for generating animation-related information based on the content of the media stored in the media database, and transmitting the animation-related information to the electronic device via the network system, the animation-related information comprising the objects of the content of the media and action parameters of actions corresponding to objects.

### BACKGROUND OF THE INVENTION

1. Field of the Invention

The present invention relates to media transmission technologies, and more particularly, to a media transmission method and a related media provider that allows fast downloading of animation-related information via a network system.

2. Description of Related Art

With the rapid development and wide application of personal computers (PCs) and network technologies, people can easily and immediately obtain information from a network system. For example, publishers start to record the information contained in hard-copy books and magazines in discs for users to read through the use of a PC, in order to eliminate the environmental concern involved with the large amount of papers required for publishing hard-copy books and magazines and the time required for publishing and binding thereof. Moreover, books and magazine in electronic forms are provided on websites for allowing the users to download or read online, such that the users can obtain contents of the books and magazines via electronic devices from anywhere and at any time without physically going to a traditional bookstore to get them.

Currently, websites may not only provide book contents in writing but also in animated form which offer lively contents of media, such as animation with a plot, which motivates those who do not prefer books in written forms to learn and acquire the information. However, animation files with rich contents usually require a storage size of at least hundreds of Mbytes, and occupies a considerable amount of bandwidth during network transmission, as a result the download time increasing as well. Thus, the motivation brought by multimedia contents is compromised by the lengthy time involved for downloading the files thereof.

Additionally, speaking of the education aspect, information providers are continuously developing products related to electronic books to reduce the inconvenience for learners to carry books with them. Learners can download needed information from the network at appropriate times. Contents for teaching can also be updated immediately such that teaching consistency is obtained. Due to the combination of network technologies and electronic books, various problems involved with printing hard-copy books can be avoided. Thus, the application of electronic books in education is popular. However, downloading electronic books through the network for learning purposes often encounters the problems of lengthy download time due to large sizes of the files to be downloaded or narrow bandwidth.

In summary, there is a need for a media transmission system and method for transmitting animated files via a network without compromising the transmission time it takes to download the files.

### SUMMARY OF THE INVENTION

In the light of forgoing drawbacks, an objective of the present invention is to provide a media transmission system and a related media provider for allowing animation files to be obtained over a network without compromising for lengthy downloading time and a narrow bandwidth.

In accordance with the above and other objectives, the present invention provides a media transmission method and a related media provider. The media transmission method is used for transmitting media stored in the media provider to an electronic device including a multimedia chip and a terminal database via a network system, allowing the electronic device to analyze the received media to obtain the content of the media, the method including the steps of: establishing a summary database in the media provider; performing media content editing using the summary database of the media provider, and storing the edited content of media in a media database of the media provider; generating animation-related information based on the content of the media stored in the media database of the media provider, and sending the animation-related information to the electronic device via the network system, wherein the animation-related information includes objects of the content of the media and action parameters corresponding to respective object actions; and upon receiving the content of the media sent by the media provider, the multimedia chip of the electronic device obtaining object information from the terminal database based on the objects included in the animation-related information, and outputting the content of the media represented by the animation-related information based on the action parameters of objects included in the animation-related information.

The above step for performing media content editing further comprises performing sound recording based on the content of the media, and storing the recorded sound in the media database, such that when the media provider generates the animation-related information based on the content of the media stored in the media database, the media provider obtains sound parameters corresponding to the objects and the object actions based on the content of the media stored in the media database to generate the animation-related information.

Moreover, the above step for performing media content editing further comprises receiving a text file and analyzing and extracting texts that correspond to objects and respective object actions, and storing the analyzed and extracted result in the media database, such that when the media provider generates the animation-related information based on the content of the media stored in the media database, the media provider obtains text parameters corresponding to the objects and the object actions based on the content of the media stored in the media database to generate the animation-related information.

The media provider is provided for transmitting media to an electronic device including a multimedia chip and a terminal database via a network system, allowing the electronic device to analyze the received media to obtain the content of the media, the media provider including a summary database for storing a plurality of objects and their basic information; a media generating module for allowing a content editor who logins a media transmission system where the media provider is installed to select the objects stored in the summary database and design actions of the selected objects, and generate a content of media; a media database for storing the content of the media generated by the media generating module; and an animation-related information generating module for generating animation-related information based on the content of the media stored in the media database, and transmitting the animation-related information to the electronic device via the network system, the animation-related information comprising the objects of the content of the media and action parameters of actions corresponding to objects, so as to allow the multimedia chip of the electronic device to obtain the action parameters from the terminal database based on the objects included in the animation-related information, and output the content of the media represented by the animation-related information based on the action parameters of the objects included in the animation-related information.

The media generating module further allows the content editor to record sound, and store the recorded sound in the media database, so as to allow the animation-related information generating module to further obtain sound parameters of the actions based on the content of the media stored in the media database to generate the animation-related information.

Moreover, the media generating module further allows the content editor to receive a text file and analyze and extract texts that correspond to objects and respective object actions, and store the analyzed and extracted results in the media database, so as to allow the animation-related information generating module to obtain text parameters of the actions based on the content of the media stored in the media database to generate the animation-related information.

The media transmission method and system of the present invention has the advantages of generating animation files based on object parameters included in the animation-related information. Since the size of the animation-related information usually does not exceed 10 Mbytes, thus compares to transmitting the animation files per se in the prior art, the time for transmitting the animation-related information is effectively reduced. These advantages can be especially prominent when the media transmission system and method is applied to a teaching services or animation-services providing websites, allowing users to quickly download animation files via a network.

### BRIEF DESCRIPTION OF DRAWINGS

The present invention can be more fully understood by reading the following detailed description of the preferred embodiments, with reference made to the accompanying drawings, wherein:

FIG. 1 shows a block diagram of a media transmission system having a media provider of the preferred embodiment according to the present invention;

FIG. 2 illustrates objects and their basic information stored in a summary database of the media provider shown in FIG. 1;

FIG. 3 illustrates a flow chart illustrating how contents of media generated by a media generating module are stored in a media database of the media provider shown in FIG. 1;

FIG. 4 illustrates a flowchart of a media transmission method corresponding to the media transmission system shown in FIG. 1;

FIG. 5 illustrates the step S2 of FIG. 4 in more details, in which the operational flow of editing contents of media by the editor is performed; and

FIG. 6 illustrates the step S6 of FIG. 4 in more details, in which the operational flow of generating animation-related information is performed.

### DETAILED DESCRIPTION OF THE PREFERRED EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

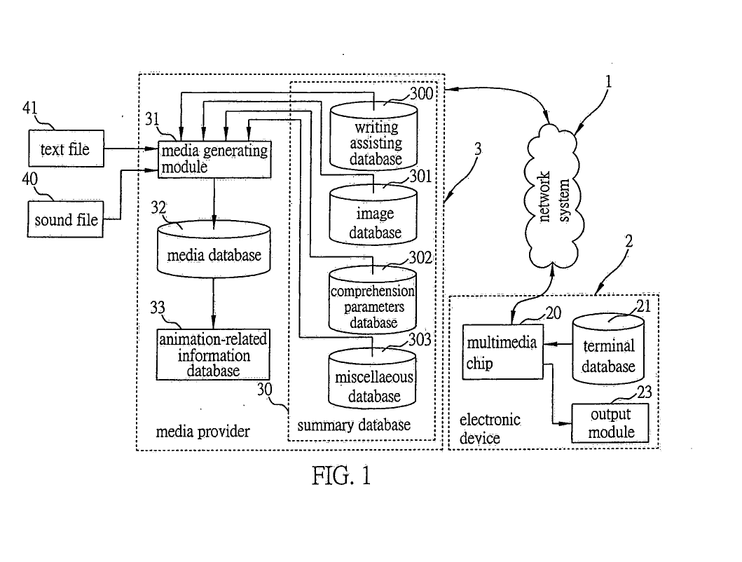

FIG. 1 shows a block diagram of a media transmission system 100 having a media provider 3 of the preferred embodiment according to the present invention. In the media transmission system 100, media stored in the media provider 3 are transmitted via a network system 1 to an electronic device 2 including a multimedia chip 20, a terminal database 21 and an output module 23. According to the preferred embodiment, the media provider 3 is for example a network server, the electronic device 2 is for example a PC, a desktop computer, a mobile phone, an electronic book (E-book) or a Personal Digital Assistant (PDA), and the network system 1 is for example an intranet within an enterprise, Internet or intranet/Internet system. A user of the electronic device 2 is allowed to download media-related information from the media provider 3 via the network system 1. On the other hand, media content providers can have the media provider 3 process media by adopting a novel for a movie scenario or creating a new drama plot. One of the best media-playing modes provided by the media transmission system 100 is an animation media-playing mode or an image-and-text media-playing mode. Moreover, in addition to the electronic device 2, the media transmission system 100 can comprises another electronic devices. Moreover, the network system 1 shown in FIG. 1 is merely a simplified network system. The media transmission system 100 can include a network system having a router, a bridge or a hub (not shown). The media provider 3 of the media transmission system 100 comprises a summary database 30, a media generating module 31, a media database 32 and an animation-related information generating module 33.

The summary database 30 comprises a writing assisting database 300, an image database 301, a comprehension parameters database 302 and a miscellaneous database 303, all of which are used to store a variety of objects and their basic information collected and complied by the media content providers in advance, allowing media editors to design required scenery and objects when editing contents of media. The writing assisting database 300 comprises a total personage database, a timeline, a list of geographic names and a total plot database (not shown herein). The image database 301 comprises a total character database, a total item database, a total scenery database and a total costume database (not shown herein). The comprehension parameters database 302 comprises a total material database, a total action database and a total knowledge database (not shown herein). According to the preferred embodiment, the miscellaneous database 303 refers to a total sound effect database (not shown herein).

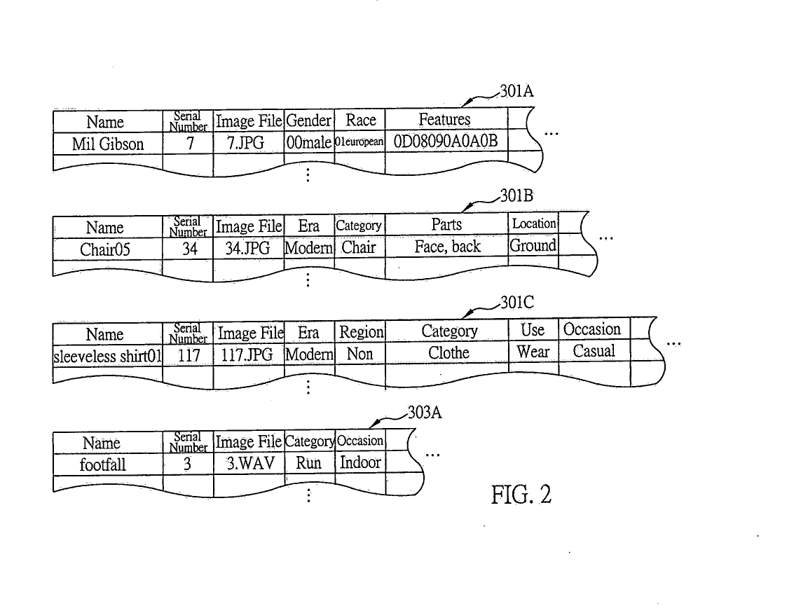

FIG. 2 illustrates four exemplary objects and their basic information stored in the summary database 30. A table 301A lists an actor's basic information stored in the total character database of the image database 301; a table 301B lists basic information of an item having an item name stored in the total item database of the image database 301; a table 301C lists basic information of a costume having a costume name stored in the total costume database of the image database 301; a table 303A lists sound-related information stored in the total sound effect database of the miscellaneous database 303.

Each of the objects stored in the summary database 30 contains an exclusive serial number (or index), such as “7”, “34”, “117” and “3” shown in the tables 301A, 301B, 301C and 303A of FIG. 2. The basic information of any one of the objects refers to attributes, characteristics or application timing, allowing the media editor to select desired objects easily when editing the contents of the media. The basic information further refers to image files of the objects. The objects and their basic information stored in the summary database 30 are the same as objects and basic information stored in the terminal database 21 of the electronic device 2. The terminal database 21 of the electronic device 2 further comprises a knowledge database for storing textual indexes, and a dynamic database for storing name indexes, event indexes, geographic-name indexes and object-name indexes (not shown).

The media generating module 31 is installed for a user who logins to the media transmission system 100 to edit contents of media . In detail, the media generating module 31 provides a content editing table having a character cast, scenery, dialogue (dubbing) and action developments so that the media editors are allowed to select objects desired for editing contents of media from the summary database 30 and set the actions for those objects to generate contents of media.

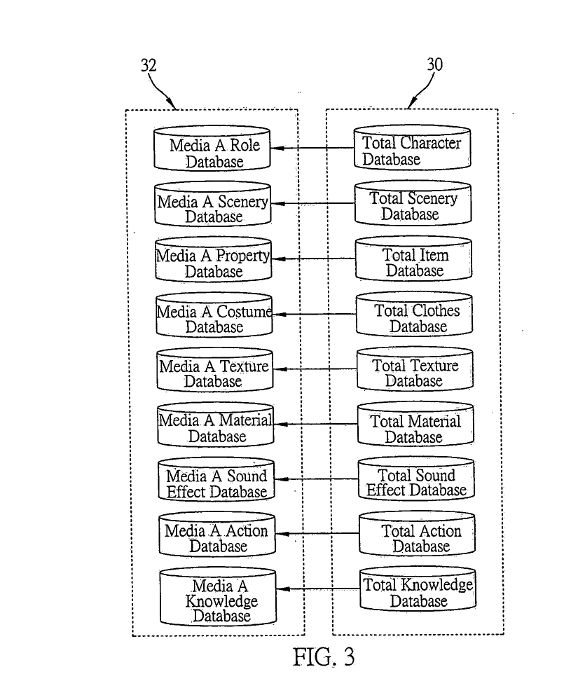

The media database 32 is used to store contents of media generated by the media generating module 31. FIG. 3 is a flow chart illustrating how the generated contents of the media generated by the media generating module are stored in the media database 32. The media generating module 31 provides the content editing table for the media editor to set the contents of the media and obtains object information from the summary database 30 based on the setting. After the editor confirms the settings, the media generating module 31 then establishes the contents of the media and stores them in the media database 32.

The animation-related information generating module 33 generates animation-related information based on the contents of the media stored in the media database 32 and the generated information is sent to the electronic device 2 via the network system 1. The animation-related information includes objects and action parameters corresponding to the objects' actions in the contents of the media, so that the multimedia chip 20 of the electronic device 2 obtains object information based on the objects included in the animation-related information and analyzes the contents of the media based on the corresponding action parameters. An output module 23 (e.g. a display) outputs the analyzed contents of media. These parameters are defined by the contents of the media set by the media generating module 31 according to the editor. For example, during media editing process, the editor can further perform sound recording according to the contents of the media, where the recorded sound file 40 is stored in the media database 32. Accordingly, the media provider 3 obtains sound parameters corresponding to the objects and their actions from the contents of the media stored in the media database 32. Thereafter, it establishes the animation-related information. The sound parameters can be for example sound instructions. For example, the animation-related information generating module 33 analyzes a voice-recorded sound file “John walks to the kitchen to get a cup” by voice recognition to generate an animation-related information, wherein the stored objects are “John”, “kitchen” and “cup”, and the objects' action parameters are John “walking” to the kitchen and “getting” the cup and as a result the cup is “moved” by John. In such a way, there is no need to create an animation file showing “John walks to the kitchen to get a cup” as in the prior art, but rather generate an animation-related information for the objects and the corresponding object actions. By performing voice recognition, analysis and calculation on the animation-related information, a sequence of animations can be created at the reader's terminal.

Moreover, during the editor performing the media editing processes, the media generating module can further receive a text file 41 (e.g. text contents in a novel), which is analyzed by the media generating module 31 to extract objects and interprets action texts corresponding to the respective objects. The extracted and interpreted results are used to establish the contents of the media, which are then stored in the media database 32. Thereupon, the media provider 3 obtains text parameters corresponding to the objects and their corresponding actions from the contents of the media stored in the media database 32, and thereby establishes an animation-related information. That is, the text parameters can be for example text instructions. For example, the animation-related information generating module 33 analyzes a paragraph “John walks to the kitchen to get a cup” in the text file by text recognition to generate an animation-related information, wherein the stored objects are “John”, “kitchen” and “cup”; the objects' action parameters are John “walking” to the kitchen and “getting” the cup and as a result the cup is “moved” by John. Similar to the above, there is no need to create an animation file showing “John walks to the kitchen to get a cup” as in the prior art, thus the data storage quantity required is effectively reduced.

The media provider 3 sends the information generated by the animation-related information generating module 33 to the electronic device 2 via the network system 1. The multimedia chip 20 of the electronic device 2 analyzes the animation-related information and identifies the objects and their corresponding action parameters, that is, the multimedia chip 20 extracts corresponding basic information for the identified objects from the terminal database 21, such as image files, and performs calculation on the object image files based on the identified corresponding object parameters to obtain the actions for the objects, which are then outputted on the output module 23.

The multimedia chip 20 of the electronic device 2 comprises a text data processing function, such as text comprehension, and a sound processing function, such as sound synthesizing, speech synthesizing, speech locating, speech recognition and speech comprehension. Thus, the contents of the media sent by the media provider 3 via the network system 1 is no longer video animation files with very large size, but the animation-related information with objects' basic information (e.g. object serial number or index) and the corresponding action parameters. The size of such animation-related information usually does not exceed the size of 10 Mbytes, thus the lengthy time required for downloading animation files can be effectively overcome.

Since the media transmission system of the present invention only transmits animation-related information about animation files, users can obtain lively animation files without compromising to the speed of downloading and bandwidth problem.

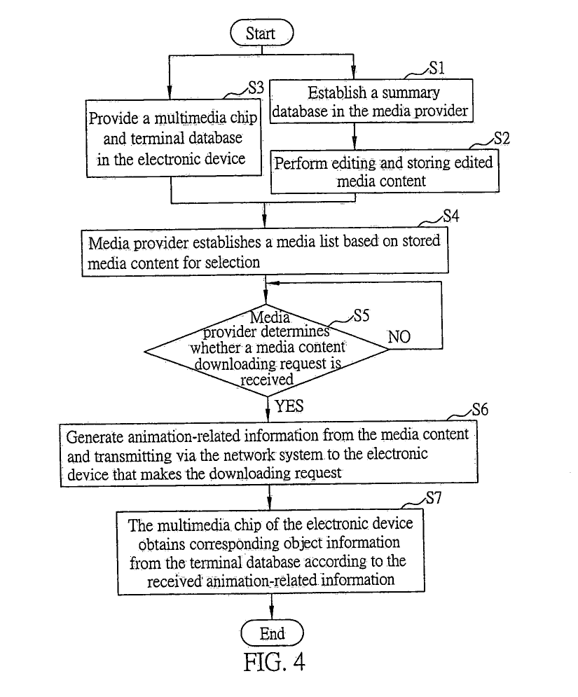

FIG. 4 illustrates an operating flowchart of the media transmission method of the present invention with reference to the media transmission system 100 described above. As shown, before a media is transmitted, step S1 and S3 is performed in advance to establish the basics for operating the media transmission method. In this embodiment, step S1 is firstly performed (in another embodiment, step S3 is performed first or simultaneously), wherein the media provider 3 establishes a summary database 30 with objects and basic information thereof, which are collected and arranged by a content provider. In this embodiment, the summary database 30 includes a writing assisting database 300, an image database 301, a comprehension parameters database 302 and a miscellaneous database 303. Each of the objects stored in the summary database 30 contains an exclusive serial number (or index), such as that shown in the tables of FIG. 2. The stored basic information of an object refers to the attribute, characteristic or application timing thereof, which facilitates the media editor in selecting the desired objects during editing of a content of media. The basic information of an object further includes the image file of the object. Then, step 2 is performed.

In step S2, a media generating module 31 of the media provider 3, upon knowing that an editor wishes to perform media content editing, provides content editing tables for the editor to set the contents of the media, where action parameters for controlling the objects can also be inputted. The object and the basic information thereof are then obtained from the summary database 30 based on the setting. After the editor confirms the settings, the media generating module 31 then stores the contents of the media in the media database 32. Then, step 4 is performed.

In step S3, the multimedia chip 20 and the terminal database 21 are built in the electronic device 2. The purpose of this step is to allow the electronic device 2 to analyze the animation-related information sent by the media provider 3. Then, step S4 is performed.

In step S4, the media provider 3 establishes a media list based on the contents of the media stored in the media database 32, so as to allow users of the media provider 3 to select the wanted media from the media list. Then, step S5 is performed.

In step S5, the media provider 3 determines whether a downloading request for a content of media is received via the network system 1. If so, step S6 is performed; else, step S5 is repeated.

In step S6, the media provider 3 makes the animation-related information generating module 33 to extract the content of the media request by the user from the media database 32. The content of the media can be for example script content, and animation-related information is generated based on the content of the media. The animation-related information is transmitted to the electronic device 2 that makes the downloading request via the network system1. Then, step S7 is performed.

In step S7, the multimedia chip 20 of the electronic device 2 extracts objects and corresponding basic information from the terminal database 21 based on the animation-related information received, so as to enable the output module 23 to play the contents of the media.

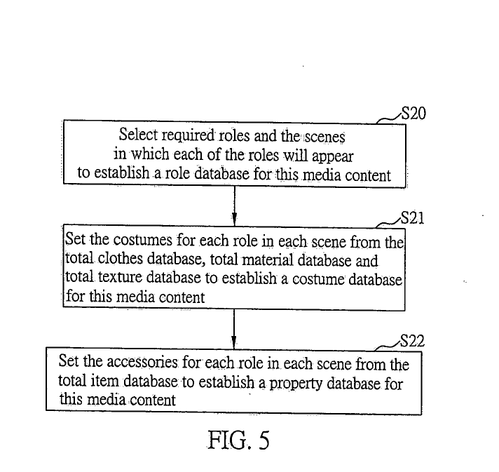

FIG. 5 illustrates the step S2 of FIG. 4 in more details, in which the operational flow of editing contents of media by the editor is performed. This embodiment uses setting of costumes for various characters in scenery as an example for illustration. Upon knowing that the editor wishes to perform media content editing (e.g. by receiving a media editing request), the media generating module 31 provides content editing tables (not shown) for the editor to set the content of the media. As shown in step S20, the editor selects the roles required for the media through the editing tables, then the media generating module 31 obtains the character objects and their corresponding basic information from the total character database of the summary database 30 based on the roles set by the editor, such as an image for the editor to confirm, then the editor sets the scenery of the content of the media in which the various characters will appear. Thereby, the role database of this content of media is established and stored in the media database 32. Then, step S21 is performed.

In step S21, the editor selects the costumes for each character in various scenes through the editing tables, then the media generating module 31 obtains the clothes and their basic information from the total clothing database of the summary database 30 based on the selected costumes, such as an image for the editor to confirm, then the editor sets desired materials and textures of the costumes, then the media generating module 31 obtains related parameters from the total material database and total texture database of the summary database 32 based on the materials and textures selected by the editor, for example, cotton cloth and silky cloth are obtained as parameters from step S20, i.e., the media generating module 31 displays the physical properties of the costume based on the parameters for the editor to confirm whether the costume properties match the requirements of the content of the media. Thereby, the costume database of this content of the media is established and stored in the media database 32. Then, step S22 is performed.

In step S22, the editor selects the accessories for each character in various scenes through the editing tables, then the media generating module 31 obtains the accessories and their basic information from the total item database of the summary database 30, such as an image for the editor to confirm, then the property database for this content of the media is established and stored in the media database 32.

It can be understood from FIG. 5 that the media provider 3 allows the editor to edit and set the contents of the media. During the editing processes, the media provider 3 obtains related objects and parameters from the summary database based the requirements of the editor. It further allows the editor to set object parameters based editing requirements, and allows the objects and object parameters of the contents of the media to be stored for use of subsequent animation-related information generating process.

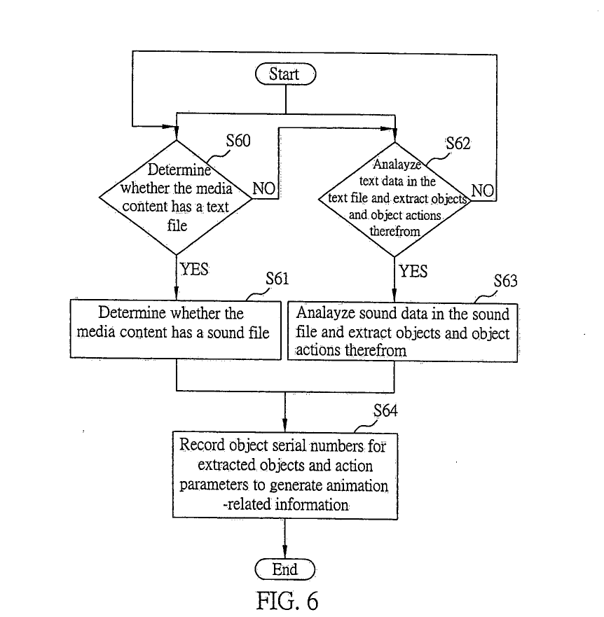

FIG. 6 illustrates the step S6 of FIG. 4 in more details, in which the operational flow of generating animation-related information is performed. The content of the media of this embodiment is a script adapted from a novel, for example. During adaptation, the content of the media can be constructed by text or sound (dubbing or dubbing and aside). The text or sound content of media can be converted into picture (motion or still) content of media. This embodiment begins with S60 (alternatively, step S62 can be performed first or simultaneously, that is, the order in which step S60 and S62 is performed is not restricted), in which the animation-related information generating module 33 of the media provider 3 determines whether the content of the media to be used for animation-related information generation is a text file, if so, then step S61 is performed; else, step S62 is performed.

In step S61, the animation-related information generating module 32 analyzes the text data in the text file, so as to analyze and extract the text parameters of objects and object actions included in the text data. Then step S64 is performed.

In step S62 (alternatively, step S60 can be performed first or simultaneously, i.e., the order of performing step S60 and S62 is not restricted), the animation-related information generating module 33 of the media provider 3 determines whether the content of the media to be used for animation-related information generation is a sound file, if so, then step S63 is performed; else, step S60 is repeated.

In step S63, the animation-related information generating module 32 analyzes the sound data in the sound file, so as to analyze and extract the sound parameters of objects and object actions included in the sound data. Then step S64 is performed.

In step S64, the animation-related information generating module 32 records the serial numbers (or indexes) of the extracted objects and object action parameters to generate animation-related information. Then, the animation-related information is sent via the network system 1 to the electronic device that makes the downloading request for the content of the media. The sound parameters may for example be sound instructions, allowing the multimedia chip 20 of the electronic device 2 to analyze the content of the media represented by the animation-related information. The text parameters may, for example, be text instructions, allowing the multimedia chip 20 of the electronic device 2 to interpret the content of the media represented by the animation-related information.

Thus, the media transmission method and system of the present invention transmits only the animation-related information instead of the animation files per se, and since the size of the animation-related information usually does not exceed 10 Mbytes, users are allowed to obtain lively animations over the network without compromising for lengthy downloading time due to a narrow bandwidth.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A media transmission method for transmitting media stored in a media provider to an electronic device including a multimedia chip and a terminal database via a network system, allowing the electronic device to analyze the received media to obtain contents of the media, the method comprising the steps of:
(1) establishing a summary database in the media provider;
(2) performing media content editing using the summary database of the media provider, and storing the edited content of the media in a media database of the media provider;
(3) generating animation-related information based on the content of the media stored in the media database of the media provider, and sending the animation-related information to the electronic device via the network system, wherein the animation-related information includes objects of the content of the media and action parameters corresponding to respective object actions; and
(4) upon receiving the content of the media sent by the media provider, having the multimedia chip of the electronic device obtain object information from the terminal database based on the objects included in the animation-related information, and outputting the contents of the media represented by the animation-related information based on the action parameters of objects included in the animation-related information.

2. The media transmission method of claim 1, wherein the step (2) for performing media content editing further comprises performing sound recording based on the media content, and storing the recorded sound in the media database, and when performing the step (3), the media provider obtains sound parameters corresponding to the objects and the object actions based on the media content stored in the media database to generate the animation-related information.

3. The media transmission method of claim 2, wherein the sound parameters refer to sound instructions, allowing the multimedia chip of the electronic device to interpret the content of the media represented by the animation-related information.

4. The media transmission method of claim 1, wherein the step (2) for performing media content editing further comprises receiving a text file and analyzing and extracting texts that correspond to objects and respective object actions, and storing the analyzed and extracted result in the media database, and when performing the step (3), the media provider obtains text parameters corresponding to the objects and the object actions based on the content of the media stored in the media database to generate the animation-related information.

5. The media transmission method of claim 4, wherein the text parameters refer to text instructions, allowing the multimedia chip of the electronic device to interpret the content of the media represented by the animation-related information.

6. The media transmission method of claim 1, wherein the summary database of the media provider and the terminal database of the electronic device comprises a plurality of objects and their basic information, where each object has an exclusive serial number, which is used to generate identification numbers for objects included in the animation-related information in the step (3), and the electronic device obtains the object information from the terminal database corresponding to the object serial numbers in the animation-related information in the step (4).

7. The media transmission method of claim 6, wherein the object information comprises object image file.

8. The media transmission method of claim 1, wherein before performing the step (3) further comprises establishing a list based on the content of the media stored in the media provider so as to allow a user of the electronic device to select a desired content of media based from the list.

9. A media provider for transmitting media to an electronic device including a multimedia chip and a terminal database via a network system, allowing the electronic device to analyze the received media and obtain contents of media, the media provider comprising:
a summary database for storing a plurality of objects and their basic information;
a media generating module for allowing a content editor who logins a media transmission system where the media provider is installed to select the objects stored in the summary database and design actions of the selected objects, and generate a content of media;
a media database for storing the content of the media generated by the media generating module; and
an animation-related information generating module for generating animation-related information based on the content of the media stored in the media database, and transmitting the animation-related information to the electronic device via the network system, the animation-related information comprising the objects of the content of the media and action parameters of actions corresponding to objects, so as to allow the multimedia chip of the electronic device to obtain the action parameters from the terminal database based on the objects included in the animation-related information, and output the content of the media represented by the animation-related information based on the action parameters of the objects included in the animation-related information.

10. The media provider of claim 9, wherein the media generating module further allows the content editor to record sound, and store the recorded sound in the media database, so as to allow the animation-related information generating module to further obtain sound parameters of the actions based on the content of the media stored in the media database to generate the animation-related information.

11. The media provider of claim 10, wherein the sound parameters refer to sound instructions for use of the multimedia chip of the electronic device to interpret the content of the media represented by the animation-related information.

12. The media provider of claim 9, wherein the media generating module further allows the content editor to receive a text file and analyze and extract texts that correspond to objects and respective object actions, and store the analyzed and extracted results in the media database, so as to allow the animation-related information generating module to obtain text parameters of the actions based on the content of the media stored in the media database to generate the animation-related information.

13. The media provider of claim 12, wherein the text parameters refer to text instructions for use of the multimedia chip of the electronic device to interpret the content of the media represented by the animation-related information.

14. The media provider of claim 9, wherein the summary database of the media provider and the terminal database of the electronic device comprise a plurality of objects and their basic information, each of the objects having an exclusive serial number as an identification number the animation-related information generating module generates for the objects included in the animation-related information, and in accordance with which the electronic device obtains the object's basic corresponding to the serial number information from the terminal database.

15. The media provider of claim 9, wherein the object's basic information comprise object image files.

16. The media provider of claim 9, wherein the media generating module further establishes a list based on the content of the media stored in the media provider, so as to allow a user of the electronic device to search the list for a desired content of media.

17. The media provider of claim 9 comprising the media provider transmission system.
